(19) United States
(12) Patent Application Publication
(10) Pub. No.: US 2026/0222439 A1
(43) Pub. Date: Jul. 30, 2026

(54) SECURITY ENGINE FOR MONITORING EDGE NODES AND ASSOCIATED DEVICES WITHIN A DISTRIBUTED NETWORK

(71) Applicant: Oracle International Corporation, Redwood City, CA (US)

(72) Inventor: René Schmitz, Venice, FL (US)

(21) Appl. No.: 19/040,040

(22) Filed: Jan. 29, 2025

(51) Int. Cl. H04L 9/40

(52) U.S. Cl. CPC H04L 63/1441; H04L 63/1416

(57) ABSTRACT

Various embodiments of the present technology generally relate to systems and methods for providing a security engine. In an example, the security engine determines a plurality of devices sharing a common connection to a network and groups these devices into a first group based on the common connection. The security engine then determines group attributes for the plurality of devices within the first group. The group attributes include at least one attribute for each device of the plurality of devices. Based on the group attributes, the security engine generates a group identifier for the first group. Using the group identifier, the security engine then monitors the devices, in particular the common connection, to detect any attribute changes. If the security engine detects an attribute change, the security engine determines whether the attribute change indicates potential malicious activity, and if it does, generates an alert based on the attribute change.

### TECHNICAL FIELD

Various embodiments of the present technology generally relate to security measures for distributed systems, including client devices or nodes connecting to networks. More specifically, embodiments of the present technology relate to systems and methods for providing a security engine for monitoring devices connected to a distributed network for potential malicious activity.

### BACKGROUND

As society becomes increasingly dependent on networked systems like the Internet of Things (IoT), the vulnerabilities inherent in these interconnected networks have become a critical concern. IoT devices, spanning everything from smart home appliances to vital infrastructure components, often lack robust security protocols, making them prime targets for cyberattacks. The expansive nature of these systems means that a single compromised device can serve as a gateway to broader network breaches, amplifying the potential impact. This growing reliance on IoT underscores the urgent need for advanced security measures to safeguard sensitive data, prevent unauthorized access, and ensure the reliability of essential services, particularly as the proliferation of connected devices continues at an unprecedented pace.

Amid this landscape, malicious activities such as spoofing attacks are becoming increasingly common as attackers exploit systemic weaknesses. MAC (Media Access Control) address spoofing, for instance, involves manipulating the hardware address of a device to mimic another device's identity, enabling attackers to bypass access controls, intercept data, or impersonate trusted devices within a network. Similarly, IP address spoofing allows attackers to forge the source IP address of data packets, often to disguise their identity during Distributed Denial of Service (DDoS) attacks or to intercept sensitive communications. ARP spoofing takes advantage of vulnerabilities in the Address Resolution Protocol by associating the attacker's MAC address with the IP address of a legitimate device, enabling man-in-the-middle (MitM) attacks. Even higher-level attacks like DNS spoofing or DNS cache poisoning redirect users to fraudulent websites by manipulating Domain Name System records, often for credential theft or malware distribution.

These spoofing methods are particularly effective because they exploit the inherent trust in identifiers like MAC and IP addresses, which are rarely verified for authenticity. Traditional security measures, such as static MAC filtering, access control lists, or basic firewalls, struggle to detect and mitigate these sophisticated techniques, leaving networks vulnerable. The rise of such advanced attacks highlights the critical need for more adaptive security solutions, such as encrypted communications, device authentication, and anomaly detection, to address the evolving threat landscape in increasingly interconnected environments.

Accordingly, there exists a need for systems and techniques for a security engine that automatically detects an attribute change for a device connected to a network. In particular, there is a need for a security engine that provides improved security measures for monitoring and identifying potential malicious activity for devices connected within a distributed network.

The information provided in this section is presented as background information and serves only to assist in any understanding of the present disclosure. No determination has been made and no assertion is made as to whether any of the above might be applicable as prior art with regard to the present disclosure.

### OVERVIEW

Technology is disclosed herein for systems and techniques for providing a security engine and one or more of its related functions. As described in greater detail below, the security engine determines a set of client devices sharing a common connection. The common connection may be provided by an edge node through which the set of client devices establish a connection with a distributed network. Based on the common connection, the security engine groups the set of client devices into a group, and in some cases, groups the edge node into the group as well. For each of the devices in the group, the security engine determines one or more attributes. These attributes may include a device serial number, MAC address, IMEI (International Mobile Equipment Identity), Subscriber Identity Module (SIM) card details, and/or other unique device identifiers. In some cases, the grouping of the devices and identification of the respective attributes is performed upon registration or initial connection of the devices to the network.

Using one or more of the attributes, the security engine generates a group identifier for the group of devices. As described in greater detail below, a hash function may be used to generate the group identifier. The security engine then uses the group identifier to detect an attribute change with respect to the devices. If one of the client devices and/or the edge node changes an attribute, such as a MAC address or SIM card details, the security engine may identify this attribute change and determine whether or not the attribute change indicates potential malicious activity. If the attribute change indicates potential malicious activity, the security engine may generate an alert indicating the attribute change. The alert may be transmitted to a respective client device and/or provided on a security interface.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

The accompanying drawings, which are incorporated into and constitute a part of this specification, illustrate one or more certain aspects and, together with the description of the example, serve to explain the principles and implementations of the certain examples.

FIG. 1 illustrates an example operational environment in which a security engine is implemented to monitor for malicious activity within a distributed network, according to an embodiment herein;

FIG. 2 illustrates an example operational environment in which a security engine is implemented to identify and respond to potential malicious activity within a distributed network, according to an embodiment herein;

FIG. 3 provides an example security engine process, according to an embodiment herein;

FIG. 4 provides an example group of connected devices within a distributed network, according to an embodiment herein; and

FIG. 5 shows an example computing device suitable for providing a security engine and its related functions, according to an embodiment herein.

Some components or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Network communication is the backbone of modern society, seamlessly connecting individuals, businesses, and systems in an ever-evolving digital age. It enables the instantaneous transfer of information across vast distances, powering critical infrastructure, global commerce, education, and social interaction. From the intricate web of cell towers, satellites, and data centers that support global communication networks to the Internet of Things (IoT) devices that automate and enhance everyday tasks, these interconnected systems ensure continuous connectivity and drive innovation in countless fields. However, as society becomes increasingly dependent on networked technologies, this growing reliance also introduces significant vulnerabilities that can be exploited by cybercriminals.

IoT devices, ranging from smart home appliances to essential infrastructure components, are often lacking in robust security protocols, making them prime targets for malicious activity. The expansive nature of these systems means that a single compromised device can act as a gateway to broader network breaches, amplifying the potential impact of an attack. The vulnerabilities inherent in these interconnected networks have become a critical concern, as attackers exploit weak authentication mechanisms, gaps in protocols, and implicit trust in identifiers. Spoofing attacks, in particular, are among the most common tactics used to impersonate trusted devices or systems. MAC address spoofing, IP address spoofing, and ARP spoofing allow attackers to bypass security measures, hijack sessions, intercept sensitive data, or manipulate communications within a network. These attacks often remain undetected because traditional security frameworks rely on unverified identifiers, like MAC or IP addresses, without properly authenticating their legitimacy.

The consequences of these cyberattacks can be severe and far-reaching. When attackers impersonate trusted devices, they can gain unauthorized access to sensitive information, such as personal data, financial details, or intellectual property. This breach of privacy can lead to identity theft, financial loss, and long-term reputational damage for businesses. In cases like man-in-the-middle (MitM) attacks or session hijacking, attackers can intercept and manipulate communications, leading to the theft of confidential information, the spread of malware, or even the disruption of critical services. For organizations, the impact can be catastrophic, causing downtime, loss of customer trust, and potential regulatory fines for failing to protect sensitive data. Spoofing attacks can also serve as entry points for more sophisticated threats, such as Distributed Denial of Service (DDoS) attacks, amplifying the damage and further disrupting business operations. These cascading effects often extend beyond immediate financial losses, affecting long-term business continuity and, in some cases, national security-especially when critical infrastructure is compromised.

One of the primary challenges in defending against these attacks is that conventional security frameworks struggle to identify spoofing and other similar attacks due to the inherent trust placed in identifiers like IP and MAC addresses. Traditional security measures, such as firewalls, intrusion detection systems (IDS), and static authentication mechanisms like MAC filtering or IP whitelisting, often fail to detect attacks because they monitor traffic patterns or rely on known signatures without verifying the authenticity of the devices involved. This leaves networks vulnerable to sophisticated attacks that exploit these weaknesses. With the proliferation of interconnected devices and the increasing complexity of modern networks, these vulnerabilities are further exacerbated, creating more opportunities for attackers to exploit gaps in security. Accordingly, there exists a need for more adaptive, dynamic, and robust security measures to safeguard against the evolving threat landscape posed by these advanced cyberattacks.

To address at least the above shortcomings of conventional security frameworks for distributed systems, an example security engine is provided herein. As will be expanded on in greater detail below, the security engine determines client devices sharing a common connection to the network. For example, the security engine detects an edge node, such as a Cloud Connector, that connects a group of client devices to the network. Based on the shared connection, provided via the edge node in this example, the security engine groups the client devices together. Once grouped together, the security engine determines one or more attributes for each of the client devices. Example attributes include the device serial number, MAC address, IMEI (International Mobile Equipment Identity), SIM card details, and/or other unique device identifiers.

Once the attributes for the group of devices are identified, the security engine selects at least one attribute for each device and generates a group identifier based on the selected attributes. For example, the security engine selects the MAC address of each of the devices within the group to generate the group identifier. Using the MAC address of each device, the security engine performs a hash function to generate the group identifier. In some embodiments, the security engine also identifies one or more attributes of an associated edge node, if applicable, and includes a node attribute in the group identifier generation process.

Once the group identifier is generated, the security engine monitors the common connection of the devices in real-time to determine whether any of the attributes change. That is, as a device in the group connects to the network, one or more of the device's attributes is recorded by the security engine. For example, if the client device is connecting to the network via a Wi-Fi router (e.g., an edge node), the Wi-Fi router records the MAC address of the client device. The security engine is in operable communication with the Wi-Fi router and records the MAC address as the client device is connected to the internet. Using the MAC address, the security engine then generates a current group identifier using the current MAC address and determines whether or not the current group identifier matches the previously generated or initial group identifier. If the current group identifier matches the previous or initial group identifier, the security engine verifies that the client device is likely authentic. In contrast, if the current group identifier mismatches the previous or initial group identifier, then the security engine generates an alert indicating potential malicious activity.

Since the attributes of client devices, such as MAC address, SIM card details, and IMEI, are unlikely to change for a respective device, any change to one of these attributes may indicate potential malicious activity. For instance, a change in the MAC address could suggest a spoofing attempt, where an attacker alters the MAC address to bypass network security measures or impersonate another device. Similarly, if the IMEI number or SIM card details change unexpectedly, it may signal fraud or device cloning, where an attacker attempts to use a stolen or counterfeit device to gain unauthorized access to a network or service since its unlikely that these attributes would change under normal conditions. By detecting these types of changes, the security engine can flag potential malicious activity for network security systems.

By monitoring device attributes of a group of devices, rather than individually, the security engine can gain a more comprehensive and accurate understanding of the behavior of connected devices. Group monitoring enables the identification of patterns and relationships between devices, helping to spot anomalies that may not be apparent when attributes are considered in isolation. Additionally, group monitoring can improve the efficiency of security operations by reducing the complexity of tracking individual attributes. Rather than individually checking each device's attributes for inconsistencies, a more holistic approach allows the security engine to flag suspicious behavior across a set of devices. Ultimately, by monitoring a group of devices as a single cohesive unit within the distributed network, the security engine streamlines detection, enhances threat visibility, and improves overall security posture, particularly in large, dynamic networks with many interconnected devices.

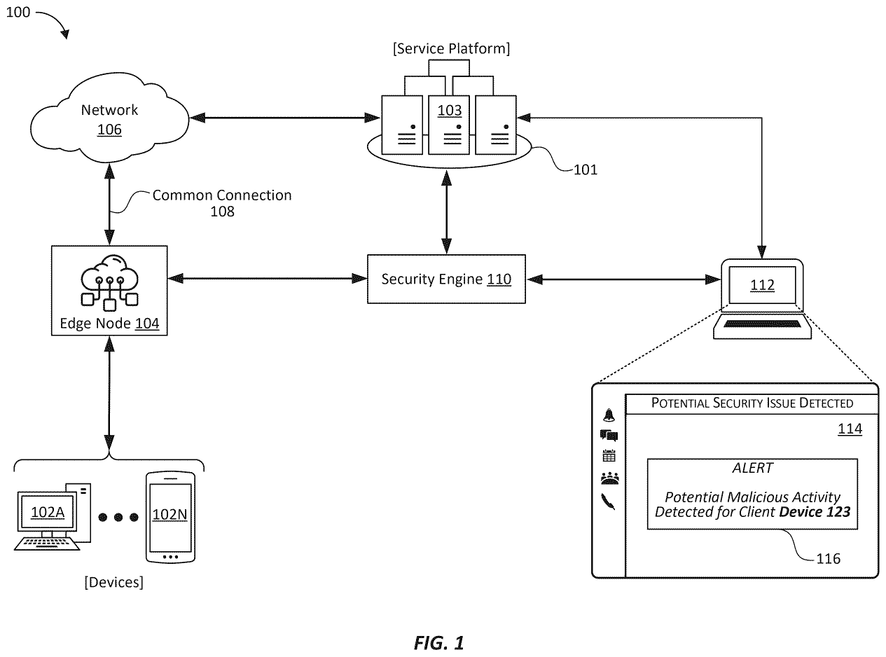

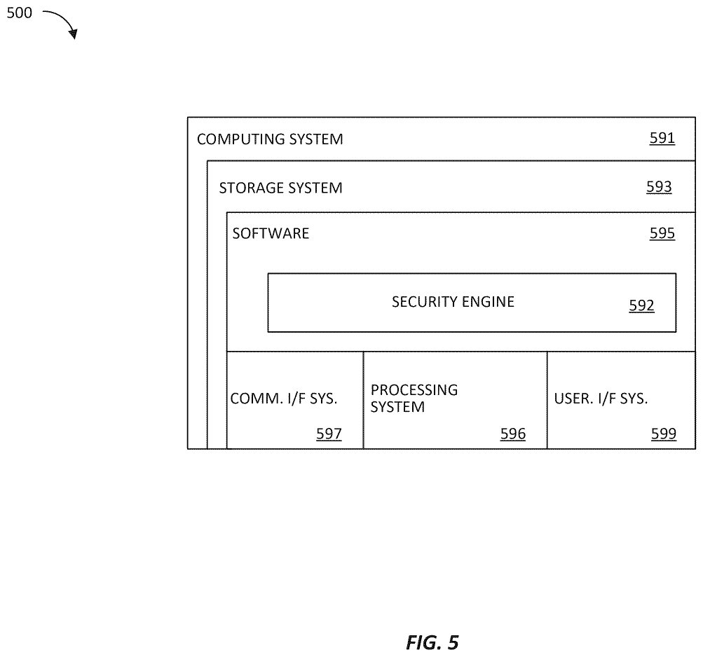

Turning now to the Figures, FIG. 1 illustrates an example operational environment 100 in which a security engine 110 may be implemented to monitor for malicious activity within a distributed network, according to an embodiment herein. In particular, the security engine 110 is leveraged to monitor the security of client devices 102A-N when connected to a network 106. As such, the security engine 110 may be in operable communication with the client devices 102A-N. Examples of the client devices 102A-N may include personal computers, tablet computers, mobile phones, gaming consoles, wearable devices, Internet of Things (IoT) devices, and any other suitable devices, of which computing apparatus 591 in FIG. 5 is also broadly representative.

The network 106 may encompass a variety of network types, tailored to the needs of the connected systems. Examples include communication networks such as 4G or 5G cellular networks, which enable high-speed data transfer and low-latency communication for mobile devices. Alternatively, the network 106 may function as a local area network (LAN) for connecting devices within a limited geographical area, or a wide area network (WAN) for linking systems across broader distances. Wireless networks, such as Wi-Fi, or satellite networks for remote connectivity, are also possibilities. In some implementations, the network 106 may be a hybrid network combining these technologies to provide seamless and efficient connectivity, depending on the underlying infrastructure and the specific requirements, such as bandwidth, latency, or security.

In the illustrated example, the network 106 is supported by a service platform 101, which acts as the backbone for managing and delivering network resources required by the network 106. The service platform 101 includes servers 103 which may vary in type, such as web servers for hosting websites and delivering web-based applications, application servers for running enterprise-level applications, and virtual or physical servers for scalable processing and data storage. These servers 103, collectively represented by computing apparatus 591 in FIG. 5, ensure reliable operation and facilitate advanced functionalities such as virtualization, load balancing, and network orchestration. The service platform 101 may also include specialized hardware and software to support network management, authentication, and security protocols, providing a robust foundation for both public and private network deployments.

As illustrated, the client devices 102A-N are connected to the network 106 via an edge node 104. The edge node 104 may be a cloud connector, a wireless router, a gateway device, or another intermediary network device that establishes a common connection 108 for the client devices 102A-N to the network 106. The edge node 104 facilitates communication between the client devices 102A-N and the network 106 by performing functions such as traffic routing, protocol translation, and network address translation (NAT). Additionally, the edge node 104 may include security features, such as firewalls or intrusion detection systems, to protect the connected client devices 102A-N from unauthorized access or cyber threats. This architecture ensures efficient and secure data transmission between the client devices 102A-N and the network 106.

To enhance the overall security framework, the edge node 104 is in operable communication with a security engine 110. As will be described in greater detail below, the security engine 110 is designed to actively monitor, detect, and mitigate potential malicious activity originating from the client devices 102A-N. In some embodiments, the security engine 110 is in operable communication with the service platform 101 in addition to or in place of the edge node 104, enabling it to oversee and safeguard interactions between the client devices 102A-N, the network 106, and the service platform 101.

The security engine 110 is deployed and executed remotely by the service platform 101. This means that, while the security engine 110 is not physically co-located with the edge node 104 or the client devices 102A-N, it is capable of interacting with them to deliver various security functions, as described herein. This architecture allows for centralized management and monitoring of the edge node 104 and client devices 102A-N, ensuring consistent and scalable security coverage. It should be appreciated that while only one edge node 104 is depicted as connecting the client devices 102A-N to the network 106, any number of edge nodes 104 may establish connections to the network 106 for any number of client devices 102A-N. Additionally, while the client devices 102A-N connect to the network 106 via the edge node 104, in some cases, one or more of the client devices 102A-N may establish a connection directly to the network 106 without the edge node 104.

As noted above, the security engine 110 monitors devices, such as the client devices 102A-N during interactions with the network 106 to identify and respond to potential threats within the distributed network 106. To identify and respond to potential malicious activity, the security engine 110 groups the client devices 102A-N together to form a first group. In particular, the security engine 110 may determine that the client devices 102A-N are related to one another and group the client devices 102A-N based on this relationship. A relationship between the client devices 102A-N may be determined based on the client devices 102A-N sharing a common characteristic, such as the common connection 108, a common location, a common organization, and the like. In the illustrated example, the security engine 110 determines that the client devices 102A-N share the common connection 108 provided by the edge node 104 and based on the common connection 108 group the client devices 102A-N together.

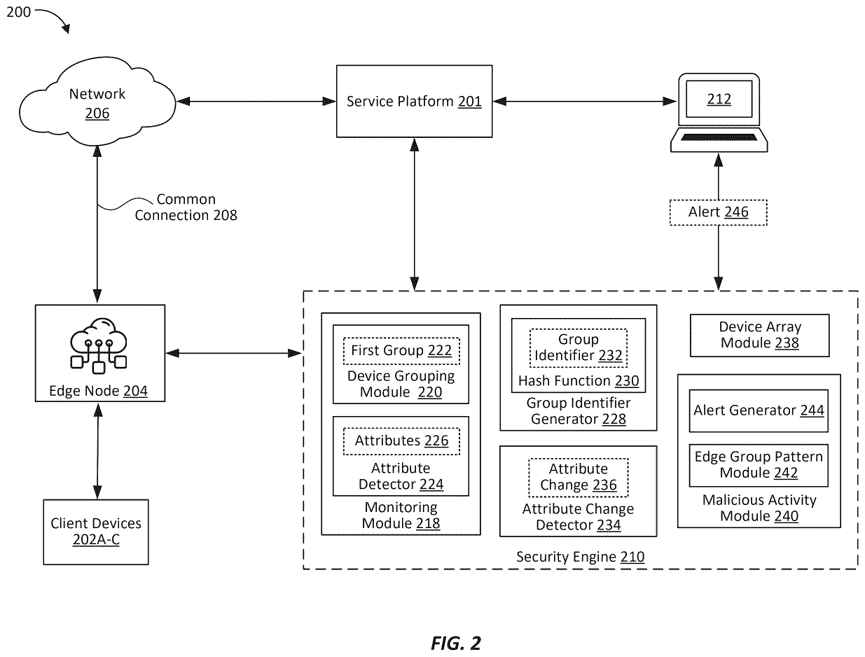

As can be appreciated, the security engine 110 may monitor hundreds if not thousands of client devices 102A-N connected to the network 106. As such, the security engine 110 identifies multiple groups of devices connected to the network 106. Once a group of client devices 102A-N is identified, the security engine 110 generates a group identifier for each group. As will be described in greater detail below, the group identifier is generated based on the attributes of the client devices 102A-N within the group, such as each device's serial number, MAC address, IMIEI, SIM card details, and/or other unique device identifiers. Generation of the group identifier is described in greater detail below with respect to FIGS. 2-4.

Using the group identifier, the security engine 110 monitors the client devices 102A-N as they connected via the network 106. That is, each time a respective client device 102A-N connects to the network 106, the security engine 110 checks the respective device's attributes against the group identifier. For instance, the security engine 110 may regenerate the group identifier using the attribute of the client devices 102A-N at a current time of connection to the network 106. If a device's attribute changes, then the security engine 110 may detect this change because a subsequently generated group identifier may not match the original group identifier. As noted above, by monitoring the client devices 102A-N as a group identity, the security engine 110 can readily detect any attribute changes for an individual device that would otherwise go undetected if the client devices 102A-N were assessed individually.

In some embodiments, the security engine 110 determines whether an identified attribute change is consistent with an edge group pattern associated with the client devices 102A-N. For example, the security engine 110 may query the service platform 101 to determine whether the attribute change matches the edge group pattern associated with the client devices 102A-N or is part of a valid action. For example, the security engine 110 may detect that an MAC address associated with the client device 102A changed but validate with the service platform 101 that this attribute change is expected or authorized. For example, the client device 102A is authorized to sign-in via a Virtual Private Network (VPN). If the attribute change is not validated, either as matching the edge group pattern of the client devices 102A-N or matching an authorized changed, the security engine 110 may categorize the attribute change as potentially malicious activity.

In an example embodiment, the security engine 110 is leveraged as part of a security system or framework associated with the service platform 101. As such, when the security engine 110 detects an attribute change for a particular client device, such as the client devices 102A, the security engine 110 notifies a client device 112 associated with the service platform 101 and/or the security system. The client device 112 may be associated with a user whose role it is to monitor the security of the network 106 and/or the service platform 101. As such, responsive to detecting an attribute change, the security engine 110 generates and sends an alert 116 to the client device 112. The alert 116 is displayed via a user interface 114 on the client device 112 and may contain information about the detected attribute change. As described in greater detail below, in some cases, detection of the attribute change may also trigger one or more automatic actions, such as quarantine or isolation of the affected client device 102A.

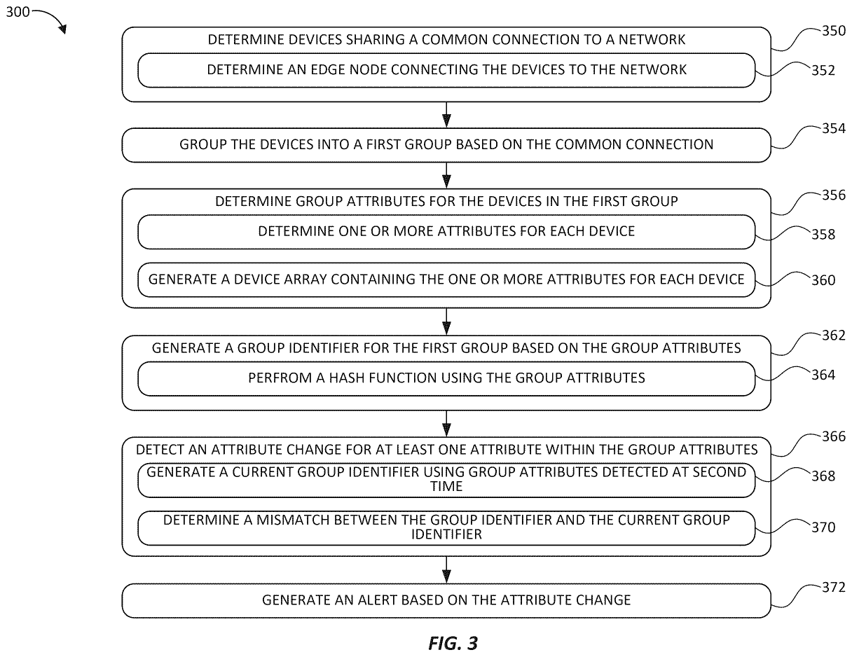

Referring now to FIG. 2, an example operational environment 200 in which a security engine 210 is implemented to identify and respond to potential malicious activity within a distributed network is provided, according to an embodiment herein. For ease of explanation, FIG. 2 is described in conjunction with FIG. 3, which provides an example security engine process, in particular a process 300 for providing the security engine 210 and one or more of its functions, respectively, according to an embodiment herein. While FIG. 3 is described with relation to FIG. 2, it should be appreciated that components, elements, and steps from any other Figures described herein may be equally applicable.

As illustrated, client devices 202A-CA-C are connected to a network 206 via an edge node 204, which may be the same or similar to the client devices 102A-N, the network 106, and the edge node 204, respectively. It should be noted that although the edge node 204 is depicted as a separate component from the client devices 202A-C, in certain scenarios, the edge node 204 may be integrated into the client devices 202A-C. For instance, the client devices 202A-C could be a mobile or cellular device with an internal edge node 204, enabling seamless connection to the network 206, which may be a communications network. Additionally, it should be appreciated that while the client devices 202A-C are connected to the network 206 via the edge node 204, in some scenarios, one or more of the client devices 202A-C may connect to the network 206 directly (e.g., not through the edge node 204).

The network 206 is provided by a service platform 201, which may be the same or similar to the service platform 101. As such, the service platform 201 manages the network 206, including monitoring network 206 and connected devices, such as the client devices 202A-C for security threats, such as potential malicious activity. Potential malicious activity, as used herein, refers to any behavior or pattern of events that deviate from established network norms or exhibit characteristics associated with known attack vectors, with a particular focus on spoofing attacks. Spoofing attacks involve the falsification of network data to impersonate legitimate devices, users, or servers, thereby enabling unauthorized access or disruption of network operations. Examples include IP spoofing, where an attacker manipulates packet headers to mask their true source address, and ARP spoofing, which exploits vulnerabilities in Address Resolution Protocol to intercept or redirect network traffic. Additional spoofing methods, such as DNS spoofing or email spoofing, may aim to mislead users or devices by impersonating trusted entities, often as part of phishing schemes or man-in-the-middle attacks.

To monitor for potential security threats, the service platform 201 is in operable communication with the security engine 210. As noted above, the security engine 210 may be installed and executed remotely by the service platform 201 while maintaining communication with the client devices 202A-C and/or the edge node 204, while in other embodiments, one or more functions of the security engine 210 may be installed and executed locally on the client devices 202A-C and/or the edge node 204, allowing for direct interaction with the device's hardware and software resources.

The security engine 210 monitors the network 206, in particular connected devices, such as the client devices 202A-C to detect potential malicious activity. To identify potential malicious activity, the security engine 210 determines a relationship between the client devices 202A-C with respect to the network 206. As noted above, this includes identifying the client devices 202A-C sharing a common connection 208 to the network 206 (350). In the illustrated example, the security engine 210 determines that the client devices 202A-C share the common connection 208 based on the client devices 202A-C using the edge node 204 to establish a connection within the network (352). Based on the common connection 208, the security engine 210 groups the client devices 202A-C into a first group (354). As noted above, the security engine 210 determines a relationship between the client devices 202A-C for the following grouping process, and this relationship could be a shared location, common location, common organization, SIM card attributes, device or component serial numbers, and the like.

In some embodiments, the security engine 210 includes a monitoring module 218 containing a device grouping module 220. The device grouping module 220 determines related devices, such as the client devices 202A-C sharing the common connection 208. Based on the common connection 208, the device grouping module 220 groups the client devices 202A-C into the first group 222. In some embodiments, the device grouping module 220 includes the edge node 204 as part of the first group 222. As noted above, under standard operating conditions, hundreds if not thousands of client devices 202A-C may connect to the network 206 via multiple edge nodes 204. As such, the device grouping module 220 may group these client devices into multiple groups along with each respective edge node 204. For instance, the device grouping module 220 may identify a first group 222 including the client devices 202A-C and the edge node 204, a second group (not shown) including a second set of client devices and a respective edge node, and a third group (not shown) including a third set of client devices and a respective edge node.

In some embodiments, the first group 222 may include more than one edge node 204. For instance, within a building, a first cloud connector—such as an edge node 204—may connect a first set of client devices, such as the client devices 202A-C, to the network 206. Similarly, a second cloud connector, which may be the same or similar to the edge node 204, connects a second set of client devices, which may be the same or similar to the client devices 202A-C, to the network 206. Since both sets of client devices are located within the same building, the security engine 210 groups them together into the first group 222. As such, the first group 222 includes both edge nodes 204, as the client devices rely on their respective cloud connectors to access the network 206.

Once the client devices 202A-C are grouped into the first group, the security engine 210 determines group attributes for the devices within the first group 222 (356). In particular, the monitoring module 218 of the security engine 210 may include an attribute detector 224 that detects attributes 226 of the devices included in the first group 222. For example, the attribute detector 224 determines one or more attributes for each of the client devices 202A-C, and in some cases the attributes for the edge node 204 (358).

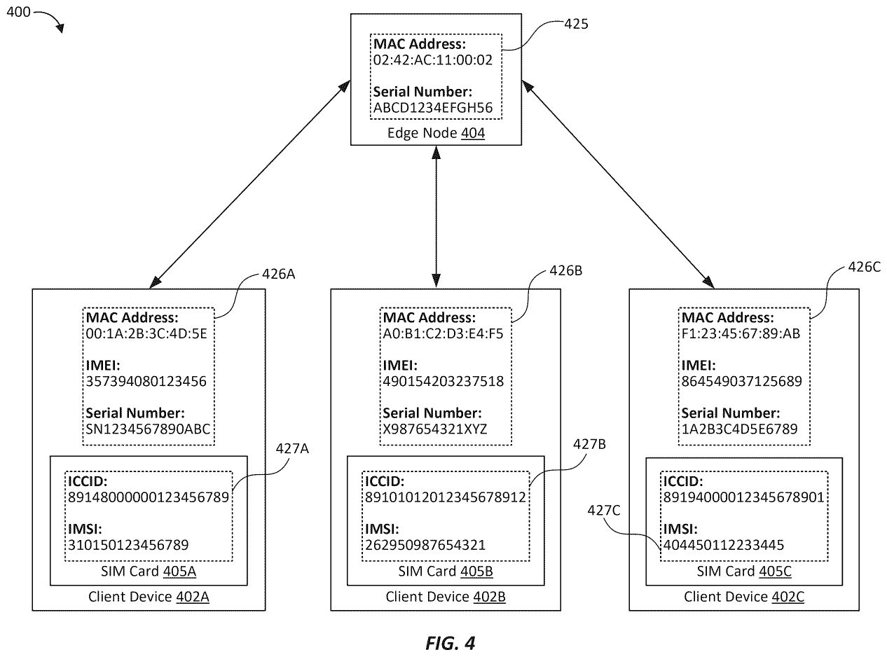

Referring now to FIG. 4, an example group 400 of connected devices within a distributed network is illustrated, according to an embodiment herein. The example group 400 includes client devices 402A-C, which may be the same or similar to the client devices 202A-C. Each of the client devices 402A-C is connected to an edge node 404, which may be the same or similar to the edge node 204, to access a broader network, such as the network 206. Because the client devices 402A-C leverage the edge node 404 to access the broader network, the security engine 210 groups the client devices 402A-C and the edge node together 444 into the group 400.

As shown, each of the client devices 402A-C includes a respective set of attributes 426A-C. That is, each of the client devices 402A-C has a respective MAC address, IMEI, and serial number(s), which are identified as the device's respective attributes 426A-C. The attributes 426A-C may vary depending on the type of device that a respective client device 402A-C is. For example, if a client device 402A is a smartphone, its attributes 426A may include additional identifiers such as an IMSI (International Mobile Subscriber Identity), device model, and operating system version. Conversely, if the client device 402B is a laptop, its attributes 426B may include a host name, processor type, installed memory, and operating system details. Similarly, if the client device 402C is an IoT device, then its attributes 426C may include device type (e.g., sensor, actuator), firmware version, serial numbers, and communication protocol (e.g., Zigbee, Bluetooth, or Wi-Fi).

As shown, each of the client devices 402A-C also includes a SIM card 405A-C, respectively. Each of the SIM cards 405A-C includes its own set of attributes 427A-C. The SIM cards 405A-C include an Integrated Circuit Card Identifier (ICCID) and an IMSI. In some embodiments, the security engine 210 may determine the attributes 427A-C or a subset of the attributes 427A-C for generation of a group identifier, as described in greater detail below.

In some embodiments, the security engine 210 also determines attributes 425 of the edge node 404. Since the edge node 404 establishes or aids in connecting the client devices 402A-C to the broader network, the edge node 404 is also susceptible to malicious activity. As such, the security engine 210 monitors the attributes 425 of the edge node 404 in addition to the attributes 426A-C of the client devices 402A-C. Attributes 425 of the edge node 404 may include a MAC address, IMEI, SIM details, such as Embedded Circuit Card Identifier (ECCID), International Mobile Subscriber Identity (IMSI), and Mobile Station International Subscriber Directory Number (MSISDN), device serial number, Embedded Identity Document (EID) for eSIM, or other unique identifiers of the edge node 404.

Returning now to FIG. 2, the attribute detector 224 determines the attributes 226 for the first group 222, which includes the attributes of the client devices 202A-C, such as the attributes 426A-C, and the attributes of the edge node 204, such as the attributes 425. In some embodiments, the security engine 210 then generates a device array for each of the client devices 202A-C and the edge node 204 (360). In particular, the security engine 210 may include a device array module 238 that generates a device array for each of the devices (e.g., the client devices 202A-C and the edge node 204). In some embodiments the device array module 238 may generate a single device array for all the devices within the first group 222, while in other embodiments, the device array module 238 may generate an individual device array for each of the devices within the first group 222.

The device array may be a table that lists the attributes 226 for each of the devices. As will be described in greater detail below, the device array may be a record of the attributes 226 for each device against with the security engine 210 verifies or validates whether or not an attribute change indicates potential malicious activity. In some embodiments, the device array module 238 stores the device array for the devices in the first group 222 locally, while in other embodiments, the device array module 238 stores the device array for the first group 222 remotely, such as within the service platform 201. 210 Table 1 provided below illustrates an example device array that the security engine 210 generates for the client device 402A.

TABLE 1
ARRAY FOR CLIENT DEVICE 402A

| MAC Address: | 00:1A:2B:3C:4D:5E |
|---|---|
| IMEI: | 357394080123456 |
| Serial Number: | SN1234567890ABC |
| ECCID: | 89014103211118510720 |
| IMSI: | 310150123456789 |
| MSISDN: | +1234567890 |

Once the client devices 202A-C, and in some cases, the edge node 204, are grouped together, the security engine 210 generates a group identifier 232 for the first group 222 (362). The group identifier 232 may be an alphanumeric value that represents the first group 222 for monitoring purposes, as described below. To generate the group identifier 232, the security engine 210 includes a group identifier generator 228 that generates the group identifier 232 using one or more of the attributes 226. In some cases, one attribute for each device (e.g., the client devices 202A-C and the edge node 204) is selected for generation of the group identifier 232, while in other embodiments, more than one attribute for each device is selected for each device. In some cases, the attribute selected for each device is the same attribute, such as the MAC address or IMEI for each device, while in other cases, the selected attributes are different for each device. For example, the MAC address is selected for the client device 202A, the IMEI is selected for the client device 202B, and the device serial number is selected for the client device 202C. This variability in attribute selection makes it difficult for attackers to spoof or predict the group identifier 232, as they are unaware of the exact attributes used in its generation.

It should be appreciated that one or more attributes 226 for each device may be selected and each selected attribute 226 may not be the same attribute. For example, an IMEI is selected for the client device 202A, the MAC address is selected for the client device 202B, and an ECCID is selected for the client device 202C. In some cases, attributes 226 that are not in use may be selected. For instance, if the client device 202A includes multiple MAC addresses, and only one is in use, the security engine 210 may select a non-active MAC address (e.g., a MAC address not in use) as the attribute 226. In still other examples, the security engine 210 may leverage unique identifiers of peripheral components connected to the client devices 202A-C for the group identifier generation. For example, if a camera is connected to the client device 202A, the security engine 210A may select one or more unique identifiers of the camera as the attributes 226 for the client device 202A.

In some embodiments, the group identifier generator 228 performs a hash function 230 using the group attributes 226 (364). For example, the security engine 210 selects one attribute for each of the client devices 202A-C and the edge node 204, and using these four attributes, the group identifier generator 228 performs the hash function 230 to generate the group identifier 232. The security engine 210 may select the same attribute for each of the client devices 202A-C and the edge node 204, such as the MAC address of each device, and then submit the four MAC addresses to the group identifier generator 228 for generation of the group identifier 232.

Following the above example, to generate the group identifier 232 for the group 400 of devices illustrated in FIG. 4, the security engine 210 submits the MAC address of 00:1A:2B:3C:4D:5E for the client device 402A, the MAC address of A0:B1:C2:D3:E4:F5 for the client device 402B, the MAC address of F1:23:45:67:89:AB for the client device 402C, and the MAC address of 02:42:AC:11:00:02 for the edge node 404. When these four MAC addresses are submitted to the group identifier generator 228, the hash function 230 may generate an output of 103c32b2c8d37ae573dbd933e0fb25434fe3b78961c2b3fd25d03066b59eda59. The security engine 210 uses this output as the group identifier 232.

The hash function 230 is a mathematical algorithm that takes an input (here the selected attributes and converts it into a fixed-size string of characters, which is typically a sequence of numbers and letters. The output from the hash function 230, also known as a hash value or hash code, is unique to the given input, meaning even a small change in the input will result in a completely different hash value. As such, any variations or changes to the selected attributes for the client devices 202A-C and edge node 204 will result in a different output. As described below, the security engine 210 uses this different output to detect and identify attribute changes that could implicate malicious activity. Examples of the hash function 230 include MD5 (Message Digest Algorithm 5), SHA-256 (Secure Hash Algorithm 256-bit), and CRC32 (Cyclic Redundancy Check).

By using the hash function 230 to generate the group identifier 232, the security engine 210 offers numerous advantages in data management and security. By converting the attributes 226 into a unique, fixed-length hash value, the hash function 230 ensures that each group of client devices 202A-C receives a distinct identifier, even when inputs have similarities or overlaps. This approach simplifies data storage and retrieval by mapping large or variable-length data sets into a compact and manageable format, enabling rapid lookup of relevant information without needing to process lengthy original data. The deterministic nature of the hash functions 230 ensures consistency, as the same input will always yield the same group identifier 232, maintaining data integrity and preventing conflicts. Additionally, the one-way nature of hash functions 230 enhances security and privacy by protecting sensitive information, as the original input (e.g., attributes 226) cannot be reverse-engineered from the hash value. In distributed systems and peer-to-peer networks, such as the network 206, hash-based group identifiers 232 streamline data sharing and retrieval across nodes, ensuring efficient and conflict-free access. Overall, by leveraging hash functions 230, the security engine 210 provides a robust, efficient, and secure foundation for uniquely identifying and managing groups (e.g., the first group 222) in diverse applications.

Once the group identifier 232 is generated, the security engine 210 uses it to monitor the client devices 202A-C and the edge node 204 when connected to the network 206. When the client devices 202A-C and/or the edge node 204 establish a connection to the network 206 via the common connection 208, each respective device provides one or more of the attributes 226 as identifying information to the network 206 as part of the connection or registration process. The specific attributes 226 shared can vary depending on the type of connection established and the nature of the network 206. For instance, in a local area network (LAN) or Wi-Fi connection, the devices may provide their MAC address as part of the connection handshake to facilitate identification and communication within the network 206. In contrast, when connecting to a cellular network, the devices may provide an IMEI number or similar identifiers for authentication and tracking purposes. As such, the security engine 210 may select respective attributes 226 for generating the group identifier 232 based on the type of connection being established and/or the nature of the network 206.

In some embodiments, the group identifier 232 is generated using the attributes 226 of the client devices 202A-C and the edge node 204 at an initial registration with the network 206/application platform 201 or an initial connection with the network 206. That is, upon registration of a respective client device 202A-C with the application platform 201 and/or the network 206, the security engine 210 may determine the device's attributes 226 and generate a device array. If a new client device is added to the first group 222, such as a new client device connecting to the network 206 via the edge node 204, the security engine 210 may generate an updated group identifier that includes one or more attributes from the new client device.

At some point during its monitoring, the security engine 210 detects an attribute change for at least one attribute within the group attributes 226 (366). That is, the security engine 210 may include an attribute change detector 234 that detects an attribute change 236 for the first group 222. For example, if one of the client devices 202A-C or edge node 204 attempts to connect or connects with the network 206 using an attribute that is not the same as its original registration attribute 226 or an attribute that is different from a previous attribute used to connect to the network 206, the attribute change detector 234 detects this attribute change 236. To detect the attribute change 236, the attribute change detector 234 may generate a current group identifier using the attributes 226 of each of the client devices 202A-C and edge node 204 at the time that the new connection or connection attempt is made (368). In some cases, the attribute change detector 234 may generate a current group identifier periodically in real-time to provide constant monitoring of the client devices 202A-C and the edge node 204.

In an example, if the client device 202A connects to the network 206 at a time subsequent to when the group identifier 232 was generated, and during this connection the client device 202A uses a new MAC address (a current attribute), the security engine 210 generates a current group identifier at this time. The security engine 210 generates the current group identifier using the attributes 226 of the client devices 202B-C and the edge node 204, as well as the new MAC address of the client device 202A. Since the new attribute of the client device 202A is different than the attribute used to generate the group identifier 232, the current group identifier will not match the group identifier 232. That is, there will be a mismatch between the group identifier generated 232 previous or originally and the current group identifier generated (370).

The security engine 210 includes a malicious activity module 240 that analyzes the detected attribute change 236 to determine whether or not it indicates potential malicious activity. To determine whether or not the attribute change 236 indicates potential malicious activity, the malicious activity module 240 may determine whether or not the attribute change 236 is associated with a validated or authenticated change. For example, the client device 202A may have changed out its SIM card, and thus one or more of its attributes 226 changed. The security engine 210 detects these changed attributes when the client device 202A connects to the network 206 after changing out the SIM card. However, since the changing of the SIM card is approved or authenticated, the malicious activity module 240 may validate the attribute change 236 as approved or non-malicious activity.

As can be appreciated, approval or authentication of a respective attribute change may be provided by a governing authority, such as an organization associated with the client devices 202A-C and/or the edge node 204. The security engine 210 may be in operable communication with the governing authority, such as via the service platform 201 to receive approved or authenticated attribute changes for respective client devices.

In some embodiments, the malicious activity module 240 may evaluate the detected attribute change 236 by comparing it to an established edge group pattern. Specifically, the malicious activity module 240 may include an edge group pattern module 242 that monitors and tracks the activities of the client devices 202A-C and the edge node 204, in particular any changes to the attributes 226. This monitoring allows the edge group pattern module 242 to identify and establish an edge group pattern based on the behavior of these devices. For example, if the attributes 226 of the client devices 202A-C and/or the edge node 204 exhibit changes that follow a time-based pattern, the edge group pattern module 242 can observe and record such patterns over time. Once identified, the edge group pattern module 242 may associate this edge group pattern with the first group 222. Thus, when the attribute change 236 is subsequently detected, the malicious activity module 240 compares this change to the previously identified edge group pattern to determine alignment. If the attribute change 236 aligns or matches the established edge group pattern for the first group 222, the malicious activity module 240 may classify the attribute change 236 as non-malicious or validated.

If the malicious activity module 240 determines that the attribute change 236 is not authenticated or approved by a governing authority, and/or the attribute change 236 does not match the known edge group pattern for the first group 222, the security engine 210 generates an alert for the attribute change 236 (372). In particular, the malicious activity module 240 may include an alert generator 244 that generates an alert 246 indicating that that the attribute change 236 may indicate potential malicious activity. As shown, the severity engine 210 may transmit the alert 246 to a client device 212, which may be the same or similar to the client device 112. As described above with respect to FIG. 1, the client device 212 may be associated with a security system or application for monitoring the security of the service platform 201, including the network 206. As such, the security engine 210 may be leveraged by this security system or application to identify potential malicious activity, such as the attribute change 236.

In some embodiments, as part of determining whether or not the attribute change 236 is a valid change (e.g., an approved change or matching of the edge group pattern), the security engine 210 determines what device or devices are associated with the attribute change 236. Following the above example where the client device 202A switches out its SIM card, upon detecting the attribute change 236 due to the SIM card change, the security engine 210 determines that the attribute change 236 is associated with the client device 202A. In some cases, the security engine 210 also determines that the client device 202A is associated with the edge node 204. In such cases, when the alert generator 244 generates the alert 246, the alert generator 244 includes identification of the client device 202A associated with the attribute change 236, a description or information on the attribute change 236 (e.g., what attribute changed and what it was previously), and in some cases, identification information on the edge node 204 associated with the client device 202A.

In some cases, the security engine 210 may categorize the attribute change 236 based on the severity of malicious activity, assigning it to a low, medium, or high threat category. For example, a low-threat attribute change might involve an IP address change caused by routine network activity, such as a device reconnecting via DHCP or moving between subnets within an expected organizational or geographic boundary. A medium-threat change could include a new SIM number or MAC address appearing for a device, which might indicate potential tampering or unauthorized usage that deviates from normal behavior but does not immediately suggest true malicious intent. In contrast, a high-threat change might involve simultaneous alterations to a device's serial number, MAC address, and IP address, especially when these changes occur without prior notice or alignment with standard device replacement or maintenance procedures. Such a scenario could indicate device spoofing, cloning, or other sophisticated attacks designed to evade detection. This categorization enables the security engine 210 to assess threats accurately and prioritize responses based on the potential risk level. It should be appreciated that any type or number of categories may be used by the security engine 210 and the use of low threat, medium threat, and high threat categories is illustrative only.

As part of the classification process, the security engine 210 may compare the current attributes of the devices associated with the attribute change 236 to the device array. Following the SIM card change example, upon detecting this attribute change 236, the security engine 210 may determine the other attributes 226 of the client device 202A at this time, such as MAC address, IP address, device serial number, etc. The security engine 210 then compares these current attributes to the device array associated with the client device 202A to determine whether any of the other attributes changed. The number of attributes that changed between the device array and the current attributes determined at the time of attribute change detection, may indicate the severity of the threat or the type of malicious activity.

Following the above example, if the security engine 210 detects the SIM card change for the client device 202A, the security engine 210 may then analyze and compare additional attributes such as the current MAC address and IP address against the original or historical attributes stored in the device array. If the MAC address and IP address are both unchanged, the security engine 210 may classify the attribute change 236 (e.g., SIM card change) as a low-severity threat, potentially due to routine activity, such as the user switching to a new network. Conversely, if the security engine 210 identifies that the MAC address, IP address, and device serial number have all changed, this could suggest unauthorized access or device tampering. In this case, the security engine 210 may classify the attribute change 236 into a high threat category, prompting the security engine 210 to initiate one or more security actions.

Depending on the categorization of the attribute change 236, the security engine 210 may perform one or more security actions responsive to detecting the attribute change 236. For example, if the attribute change 236 is classified into a low threat category, the security engine 210 may simply generate the alert 246 and take no further actions. If the attribute change 236 is classified into a medium threat category, the security engine 210 may prompt the respective device to provide additional authentication information (e.g., user login information). And if the attribute change 236 is classified into a high threat category, the security engine 210 may isolate the respective device from the network 206. For example, the security engine 210 may determine a connection point for the respective device, such as the client device 202A, to the network 206 and deactivate the connection point, thereby isolating the client device 202A from the network 206. The connection point may be a port on the edge node 204 that the security engine 210 deactivates. These actions are intended to serve as examples of progressively increasing measures that may be taken based on the threat category assigned to attribute change 236.

Referring now to FIG. 5, is a diagram of a system 500 configured to implement a security engine, according to an embodiment herein. The system 500 may be an example of an apparatus including a computing apparatus 591 that is representative of any system or collection of systems in which the various processes, systems, programs, services, and scenarios disclosed herein may be implemented. For example, computing apparatus 591 may be an example security engine, such as the security engine 110 or 210, a client device, such as the client devices 102A-N, 202A-C, or 402A-C, or any of the subcomponents depicted in the operational environment 100, the operational environment 200, or the method 300, respectively. Examples of computing apparatus 591 include, but are not limited to, server computers, desktop computers, laptop computers, routers, switches, web servers, cloud computing platforms, and data center equipment, as well as any other type of physical or virtual server machine, physical or virtual router, container, and any variation or combination thereof.

Computing apparatus 591 may be implemented as a single apparatus, system, or device or may be implemented in a distributed manner as multiple apparatuses, systems, or devices. Computing apparatus 591 may include, but is not limited to, processing system 596, storage system 593, software 595, communication interface system 597, and user interface system 599. Processing system 596 may be operatively coupled with storage system 593, communication interface system 597, and user interface system 599.

Processing system 596 may load and execute software 595 from storage system 593. Software 595 may include a security engine 592, which may be representative of any of the operations for providing a security engine or any of its related functions, as discussed with respect to the preceding figures. When executed by processing system 596, software 595 may direct processing system 596 to operate as described herein for at least the various processes, such as the method 300, operational scenarios, and sequences discussed in the foregoing implementations. Computing apparatus 591 may optionally include additional devices, features, or functionality not discussed for purposes of brevity.

In some embodiments, processing system 596 may comprise a micro-processor and other circuitry that retrieves and executes software 595 from storage system 593. Processing system 596 may be implemented within a single processing device but may also be distributed across multiple processing devices or sub-systems that cooperate in executing program instructions. Examples of processing system 596 may include general purpose central processing units, graphical processing units, application specific processors, and logic devices, as well as any other type of processing device, combinations, or variations thereof.

Storage system 593 may comprise any memory device or computer-readable storage medium readable by processing system 596 and capable of storing software 595. Storage system 593 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer-readable storage medium a propagated signal.

In addition to computer-readable storage medium, in some implementations storage system 593 may also include computer readable communication media over which at least some of software 595 may be communicated internally or externally. Storage system 593 may be implemented as a single storage device but may also be implemented across multiple storage devices or sub-systems co-located or distributed relative to each other. Storage system 593 may comprise additional elements, such as a controller, capable of communicating with processing system 596 or possibly other systems.

Software 595 (including the security engine 592 among other functions) may be implemented in program instructions that may, when executed by processing system 596, direct processing system 596 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 595 may include additional processes, programs, or components, such as operating system software, virtualization software, or other application software. Software 595 may also comprise firmware or some other form of machine-readable processing instructions executable by processing system 596.

In general, software 595 may, when loaded into processing system 596 and executed, transform a suitable apparatus, system, or device (of which computing apparatus 591 is representative) overall from a general-purpose computing system into a special-purpose computing system as described herein. Indeed, encoding software 595 on storage system 593 may transform the physical structure of storage system 593. The specific transformation of the physical structure may depend on various factors in different implementations of this description. Examples of such factors may include, but are not limited to, the technology used to implement the storage media of storage system 593 and whether the computer-storage media are characterized as primary or secondary storage, as well as other factors.

For example, if the computer-readable storage medium is implemented as semiconductor-based memory, software 595 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 597 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between the computing apparatus 591 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random-access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as programmable logic controllers (PLCs), programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more memory devices or computer readable medium(s) having computer readable program code embodied thereon.

The foregoing examples and descriptions are described herein in the context of systems and methods for providing a security engine or one or more of its related functions. Those of ordinary skill in the art will realize that these descriptions are illustrative only and are not intended to be in any way limiting. Reference is made in detail to implementations of examples as illustrated in the accompanying drawings. The same reference indicators are used throughout the drawings and the description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. That is, the foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in an embodiment,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word: any of the items in the list, all the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

### Examples

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a computing apparatus comprising: a computer-readable storage medium; processor-executable instructions stored on the computer-readable storage medium; and one or more processors coupled to the computer-readable storage medium and configured to execute the processor-executable instructions to operate a security engine that is in operable communication with a plurality of edge nodes connected to a network, such that the processor-executable instructions, when executed by the one or more processors, direct the computing apparatus, to at least: determine a plurality of devices associated with a first edge node of the plurality of edge nodes, wherein the first edge node establishes a connection to the network for the plurality of devices; determine a plurality of attributes for the plurality of devices; generate a group identifier for the plurality of devices connected to the network via the first edge node; detect an attribute change within the plurality of attributes associated with the group identifier; and generate an alert of the attribute change within a security interface.

Example 2 is the computing apparatus of any previous or subsequent Example, wherein the processor-executable instructions to generate the group identifier for the plurality of devices connected to the network via the first edge node, when executed by the one or more processors, further direct the computing apparatus to: determine a node attribute for the first edge node; perform a hash function using at least one attribute for each device in the plurality of devices and the node attribute; and generate the group identifier for the plurality of devices from an output from the hash function.

Example 3 is the computing apparatus of any previous or subsequent Example, wherein the group identifier is generated using the plurality of attributes at a first time, and wherein the processor-executable instructions to detect the attribute change within the plurality of attributes associated with the group identifier, when executed by the one or more processors, further direct the computing apparatus to: determine the plurality of attributes for the plurality of devices at a second time; generate a current group identifier using the plurality of attributes determined at the second time; compare the current group identifier from the second time to the group identifier generated at the first time; and detect the attribute change within the plurality of attributes based on a mismatch between the current group identifier from the second time and the group identifier at the first time.

Example 4 is the computing apparatus of any previous or subsequent Example, wherein the processor-executable instructions to generate the alert of the attribute change within a security interface, when executed by the one or more processors, further direct the computing apparatus to: determine a first client device associated with the attribute change, wherein the plurality of devices comprises the first client device; and generate the alert comprising an identification of the first client device, the first edge node, and the plurality of devices.

Example 5 is the computing apparatus of any previous or subsequent Example, wherein the processor-executable instructions, when executed by the one or more processors, further direct the computing apparatus to: determine a first device associated with the attribute change; compare the attribute change to a device array associated with the first device; categorize the attribute change based on the comparison; and determine one or more security actions based on the categorization of the attribute change.

Example 6 is the computing apparatus of any previous or subsequent Example, wherein the processor-executable instructions, when executed by the one or more processors, further direct the computing apparatus to: generate a device array for each device of the plurality of devices, wherein the device array comprises a plurality of attributes for each device; determine a first device associated with the attribute change; and validate the attribute change based on a respective device array for the first device.

Example 7 is a method comprising: determining, by a security engine, a plurality of devices sharing a common connection to a network; grouping, by the security engine, the plurality of devices into a first group based on the common connection; determining, by the security engine, group attributes for the plurality of devices within the first group, wherein the group attributes comprise at least one attribute for each device of the plurality of devices; generating, by the security engine, a group identifier for the first group based on the group attributes; detecting, by the security engine, an attribute change for at least one attribute within the group attributes of the plurality of devices during the common connection to the network; and generating, by the security engine, an alert based on the attribute change, wherein the attribute change indicates potential malicious activity.

Example 8 is the method of any previous or subsequent Example, wherein generating, by the security engine, the group identifier for the first group based on the group attributes comprises: performing, by the security engine, a hash function using the group attributes; and generating, by the security engine, the group identifier from an output from the hash function.

Example 9 is the method of any previous or subsequent Example, wherein: the common connection to the network for the plurality of devices is established by an edge node; the method further comprises determining, by the security engine, a node attribute for the edge node; and generating, by the security engine, the group identifier for the first group comprises: generating, by the security engine, the group identifier for the first group based on the group attributes and the node attribute.

Example 10 is the method of any previous or subsequent Example, wherein the method further comprises: generating, by the security engine, a device array for each device in the first group, wherein the device array comprises a plurality of attributes for each device; determining, by the security engine, a first device associated with the attribute change; checking, by the security engine, a respective device array for the first device; and categorizing, by the security engine, the attribute change as potential malicious activity based on the attribute change and the device array for the first device.

Example 11 is the method of any previous or subsequent Example, wherein the method further comprises: monitoring, by the security engine, the common connection for the plurality of devices in real-time; and verifying, by the security engine, that the group attributes for the plurality of devices remains unchanged based on the monitoring.

Example 12 is the method of any previous or subsequent Example, wherein the network comprises a cellular network.

Example 13 is the method of any previous or subsequent Example, wherein the method further comprises: determining, by the security engine, a first device associated with the attribute change; determining, by the security engine, a threat category for the attribute change; determining, by the security engine, a security action based on the threat category of the attribute change; determining, by the security engine, a connection point for the first device to the network; and deactivating, by the security engine, the connection point to the network for the first device based on the security action.

Example 14 is a computer-readable storage medium comprising processor-executable instructions, wherein the processor-executable instructions, in part, to operate a security engine that is in operable communication with a plurality of devices connected to a network, such to cause one or more processors to: determine, by a security engine, a plurality of devices sharing a common connection to a network; group, by the security engine, the plurality of devices into a first group based on the common connection; determine, by the security engine, group attributes for the plurality of devices within the first group, wherein the group attributes comprise at least one attribute for each device of the plurality of devices; generate, by the security engine, a group identifier for the first group using the group attributes; detect, by the security engine, an attribute change for at least one attribute within the group attributes of the plurality of devices during the common connection to the network; and generate, by the security engine, an alert based on the attribute change, wherein the attribute change indicates potential malicious activity.

Example 15 is the computer-readable storage medium of any previous or subsequent Example, wherein the processor-executable instructions to generate, by the security engine, the group identifier for the first group using the group attributes cause the one or more processors to further execute processor-executable instructions stored in the computer-readable storage medium to: determine, by the security engine, at least one attribute for each respective device of the plurality of devices at a first time based on the common connection; perform, by the security engine, a hash function using the at least one attribute for each respective device of the plurality of devices; and generate, by the security engine, the group identifier from an output from the hash function at the first time.

Example 16 is the computer-readable storage medium of any previous or subsequent Example, wherein the processor-executable instructions to detect, by the security engine, the attribute change for the at least one attribute within the group attributes of the plurality of devices during the common connection to the network cause the one or more processors to further execute processor-executable instructions stored in the computer-readable storage medium to: determine, by the security engine, the at least one attribute for each respective device of the plurality of devices at a second time; perform, by the security engine, a second hash function using the at least one attribute for each respective device of the plurality of devices at the second time; generate, by the security engine, a current group identifier from a second output from the second hash function at the second time; compare the current group identifier from the second time to the group identifier generated at the first time; and detect the attribute change within the plurality of attributes based on a mismatch between the current group identifier from the second time and the group identifier at the first time.

Example 17 is the computer-readable storage medium of any previous or subsequent Example, wherein the processor-executable instructions cause the one or more processors to further execute processor-executable instructions stored in the computer-readable storage medium to: determine, by the security engine, a first client device associated with the attribute change, wherein the plurality of devices comprises the first client device; determine, by the security engine, that the attribute change comprises potential malicious activity based on the first client device; and isolate, by the security engine, the first client device from the network based on the attribute change.

Example 18 is the computer-readable storage medium of any previous or subsequent Example, wherein: the processor-executable instructions cause the one or more processors to further execute processor-executable instructions stored in the computer-readable storage medium to: select, by the security engine, a first attribute for each device in the plurality of devices, wherein the group attributes comprise the first attribute; monitor, by the security engine, the first attribute for each device within the first group in real time; and determine, by the security engine, an edge group pattern for the first group based on monitoring the first attribute of each device in the plurality of devices; and the processor-executable instructions to detect, by the security engine, the attribute change for at least one attribute within the group attributes of the plurality of devices during the common connection to the network cause the one or more processors to further execute processor-executable instructions stored in the computer-readable storage medium to: detect, by the security engine, the attribute change based on a change within the edge group pattern.

Example 19 is the computer-readable storage medium of any previous or subsequent Example, wherein the plurality of devices is connected to the network via an edge node, and wherein the processor-executable instructions to generate, by the security engine, the group identifier for the first group using the group attributes cause the one or more processors to further execute processor-executable instructions stored in the computer-readable storage medium to: determine a node attribute for the edge node; perform a hash function using at least one attribute for each device in the plurality of devices and the node attribute; and generate the group identifier for the plurality of devices from an output from the hash function.

Example 20 is the computer-readable storage medium of any previous or subsequent Example, wherein the processor-executable instructions cause the one or more processors to further execute processor-executable instructions stored in the computer-readable storage medium to: detect, by the security engine, registration of a new device to the first group; create, by the security engine, a device array for the new device, wherein the device array comprises a first set of attributes associated with the new device; and generate, by the security engine, an updated group identifier using the group attributes for the plurality of devices comprising the new device.

What is claimed is:

1. A computing apparatus comprising:
a computer-readable storage medium;
processor-executable instructions stored on the computer-readable storage medium; and
one or more processors coupled to the computer-readable storage medium and configured to execute the processor-executable instructions to operate a security engine that is in operable communication with a plurality of edge nodes connected to a network, such that the processor-executable instructions, when executed by the one or more processors, direct the computing apparatus, to at least:
determine a plurality of devices associated with a first edge node of the plurality of edge nodes, wherein the first edge node establishes a connection to the network for the plurality of devices;
determine a plurality of attributes for the plurality of devices;
generate a group identifier for the plurality of devices connected to the network via the first edge node;
detect an attribute change within the plurality of attributes associated with the group identifier; and
generate an alert of the attribute change within a security interface.

2. The computing apparatus of claim 1, wherein the processor-executable instructions to generate the group identifier for the plurality of devices connected to the network via the first edge node, when executed by the one or more processors, further direct the computing apparatus to:
determine a node attribute for the first edge node;
perform a hash function using at least one attribute for each device in the plurality of devices and the node attribute; and
generate the group identifier for the plurality of devices from an output from the hash function.

3. The computing apparatus of claim 1, wherein the group identifier is generated using the plurality of attributes at a first time, and wherein the processor-executable instructions to detect the attribute change within the plurality of attributes associated with the group identifier, when executed by the one or more processors, further direct the computing apparatus to:
determine the plurality of attributes for the plurality of devices at a second time;
generate a current group identifier using the plurality of attributes determined at the second time;
compare the current group identifier from the second time to the group identifier generated at the first time; and
detect the attribute change within the plurality of attributes based on a mismatch between the current group identifier from the second time and the group identifier at the first time.

4. The computing apparatus of claim 1, wherein the processor-executable instructions to generate the alert of the attribute change within a security interface, when executed by the one or more processors, further direct the computing apparatus to:
determine a first client device associated with the attribute change, wherein the plurality of devices comprises the first client device; and
generate the alert comprising an identification of the first client device, the first edge node, and the plurality of devices.

5. The computing apparatus of claim 1, wherein the processor-executable instructions, when executed by the one or more processors, further direct the computing apparatus to:
determine a first device associated with the attribute change;
compare the attribute change to a device array associated with the first device;
categorize the attribute change based on the comparison; and
determine one or more security actions based on the categorization of the attribute change.

6. The computing apparatus of claim 1, wherein the processor-executable instructions, when executed by the one or more processors, further direct the computing apparatus to:
generate a device array for each device of the plurality of devices, wherein the device array comprises a plurality of attributes for each device;
determine a first device associated with the attribute change; and
validate the attribute change based on a respective device array for the first device.

7. A method comprising:
determining, by a security engine, a plurality of devices sharing a common connection to a network;
grouping, by the security engine, the plurality of devices into a first group based on the common connection;
determining, by the security engine, group attributes for the plurality of devices within the first group, wherein the group attributes comprise at least one attribute for each device of the plurality of devices;
generating, by the security engine, a group identifier for the first group based on the group attributes;
detecting, by the security engine, an attribute change for at least one attribute within the group attributes of the plurality of devices during the common connection to the network; and
generating, by the security engine, an alert based on the attribute change, wherein the attribute change indicates potential malicious activity.

8. The method of claim 7, wherein generating, by the security engine, the group identifier for the first group based on the group attributes comprises:
performing, by the security engine, a hash function using the group attributes; and
generating, by the security engine, the group identifier from an output from the hash function.

9. The method of claim 7, wherein:
the common connection to the network for the plurality of devices is established by an edge node;
the method further comprises determining, by the security engine, a node attribute for the edge node; and
generating, by the security engine, the group identifier for the first group comprises:
generating, by the security engine, the group identifier for the first group based on the group attributes and the node attribute.

10. The method of claim 7, wherein the method further comprises:
generating, by the security engine, a device array for each device in the first group, wherein the device array comprises a plurality of attributes for each device;
determining, by the security engine, a first device associated with the attribute change;
checking, by the security engine, a respective device array for the first device; and
categorizing, by the security engine, the attribute change as potential malicious activity based on the attribute change and the device array for the first device.

11. The method of claim 7, wherein the method further comprises:
monitoring, by the security engine, the common connection for the plurality of devices in real-time; and
verifying, by the security engine, that the group attributes for the plurality of devices remains unchanged based on the monitoring.

12. The method of claim 7, wherein the network comprises a cellular network.

13. The method of claim 7, wherein the method further comprises:
determining, by the security engine, a first device associated with the attribute change;
determining, by the security engine, a threat category for the attribute change;
determining, by the security engine, a security action based on the threat category of the attribute change;
determining, by the security engine, a connection point for the first device to the network; and
deactivating, by the security engine, the connection point to the network for the first device based on the security action.

14. A computer-readable storage medium comprising processor-executable instructions, wherein the processor-executable instructions, in part, to operate a security engine that is in operable communication with a plurality of devices connected to a network, such to cause one or more processors to:
determine, by a security engine, a plurality of devices sharing a common connection to a network;
group, by the security engine, the plurality of devices into a first group based on the common connection;
determine, by the security engine, group attributes for the plurality of devices within the first group, wherein the group attributes comprise at least one attribute for each device of the plurality of devices;
generate, by the security engine, a group identifier for the first group using the group attributes;
detect, by the security engine, an attribute change for at least one attribute within the group attributes of the plurality of devices during the common connection to the network; and
generate, by the security engine, an alert based on the attribute change, wherein the attribute change indicates potential malicious activity.

15. The computer-readable storage medium of claim 14, wherein the processor-executable instructions to generate, by the security engine, the group identifier for the first group using the group attributes cause the one or more processors to further execute processor-executable instructions stored in the computer-readable storage medium to:
determine, by the security engine, at least one attribute for each respective device of the plurality of devices at a first time based on the common connection;
perform, by the security engine, a hash function using the at least one attribute for each respective device of the plurality of devices; and
generate, by the security engine, the group identifier from an output from the hash function at the first time.

16. The computer-readable storage medium of claim 15, wherein the processor-executable instructions to detect, by the security engine, the attribute change for the at least one attribute within the group attributes of the plurality of devices during the common connection to the network cause the one or more processors to further execute processor-executable instructions stored in the computer-readable storage medium to:
determine, by the security engine, the at least one attribute for each respective device of the plurality of devices at a second time;
perform, by the security engine, a second hash function using the at least one attribute for each respective device of the plurality of devices at the second time;
generate, by the security engine, a current group identifier from a second output from the second hash function at the second time;
compare the current group identifier from the second time to the group identifier generated at the first time; and
detect the attribute change within the plurality of attributes based on a mismatch between the current group identifier from the second time and the group identifier at the first time.

17. The computer-readable storage medium of claim 14, wherein the processor-executable instructions cause the one or more processors to further execute processor-executable instructions stored in the computer-readable storage medium to:
determine, by the security engine, a first client device associated with the attribute change, wherein the plurality of devices comprises the first client device;
determine, by the security engine, that the attribute change comprises potential malicious activity based on the first client device; and
isolate, by the security engine, the first client device from the network based on the attribute change.

18. The computer-readable storage medium of claim 14, wherein:
the processor-executable instructions cause the one or more processors to further execute processor-executable instructions stored in the computer-readable storage medium to:
select, by the security engine, a first attribute for each device in the plurality of devices, wherein the group attributes comprise the first attribute;
monitor, by the security engine, the first attribute for each device within the first group in real time; and
determine, by the security engine, an edge group pattern for the first group based on monitoring the first attribute of each device in the plurality of devices; and
the processor-executable instructions to detect, by the security engine, the attribute change for at least one attribute within the group attributes of the plurality of devices during the common connection to the network cause the one or more processors to further execute processor-executable instructions stored in the computer-readable storage medium to:
detect, by the security engine, the attribute change based on a change within the edge group pattern.

19. The computer-readable storage medium of claim 14, wherein the plurality of devices is connected to the network via an edge node, and wherein the processor-executable instructions to generate, by the security engine, the group identifier for the first group using the group attributes cause the one or more processors to further execute processor-executable instructions stored in the computer-readable storage medium to:
determine a node attribute for the edge node;
perform a hash function using at least one attribute for each device in the plurality of devices and the node attribute; and
generate the group identifier for the plurality of devices from an output from the hash function.

20. The computer-readable storage medium of claim 14, wherein the processor-executable instructions cause the one or more processors to further execute processor-executable instructions stored in the computer-readable storage medium to:
detect, by the security engine, registration of a new device to the first group;
create, by the security engine, a device array for the new device, wherein the device array comprises a first set of attributes associated with the new device; and
generate, by the security engine, an updated group identifier using the group attributes for the plurality of devices comprising the new device.
